(19) United States
(12) Patent Application Publication
(10) Pub. No.: US 2015/0363859 A1
(43) Pub. Date: Dec. 17, 2015

(54) INFER PRODUCT CORRELATIONS BY INTEGRATING TRANSACTIONS AND CONTEXTUAL USER BEHAVIOR SIGNALS

(71) Applicant: Google Inc., Mountain View, CA (US)

(72) Inventors: Wei Zhang, Fremont, CA (US); Jia Zhao, Mountain View, CA (US); Duangmanee Putthividhya, Mountain View, CA (US); Ismail Oner Sebe, Sunnyvale, CA (US); Nima Asgharbeygi, Mountain View, CA (US)

(73) Assignee: Google Inc., Mountain View, CA (US)

(21) Appl. No.: 14/162,266

(22) Filed: Jan. 23, 2014

(51) Int. Cl. G06Q 30/06

(52) U.S. Cl. CPC G06Q 30/0631

(57) ABSTRACT

Systems and methods for determining correlation scores for product pairs are provided. Contextual user behavior indicator data relating to a plurality of user behavior indicator types is received. A correlation score is computed for a first product and a second product for each user behavior indicator type from the plurality of user behavior indicator types. A final correlation score is computed for the first product and the second product by combining the computed correlation scores for each user behavior indicator type. The computed final correlation score for the first product and the second product is stored into a first data storage.

### BACKGROUND

The present disclosure relates generally to recommender systems providing recommendations to online users. The recommender systems often employ collaborative filtering techniques to make predictions of what users like based on their similarity to other users. Users may express their interests by rating items (e.g., books), purchasing items, listening to music, etc. For example, a recommender system may recommend to a user items that similar users (i.e., users who have ranked items similar to the user) have rated highly. In another example, the recommender systems may correlate products that are frequently bought together or viewed together by the same users.

### SUMMARY

A method includes, but is not limited to any combination of: receiving contextual user behavior indicator data relating to a plurality of user behavior indicator types; computing a correlation score for a first product and a second product for each user behavior indicator type from the plurality of user behavior indicator types; computing a final correlation score for the first product and the second product by combining the computed correlation scores for each user behavior indicator type; and storing the computed final correlation score for the first product and the second product into a first data storage.

A system including: a receiver configured to receive contextual user behavior indicator data relating to a plurality of user behavior indicator types; a recommender module configured to compute a correlation score for a first product and a second product for each user behavior indicator type from the plurality of user behavior indicator types, and compute a final correlation score for the first product and the second product by combining the computed correlation scores for each user behavior indicator type; and a data storage configured to store the computed final correlation score for the first product and the second product into a first data storage

A computer-readable storage medium having machine instructions stored therein, the instructions being executable by a processor to cause the processor to perform operations comprising: receiving a request for a product recommendation for a first product; determining a product recommendation based on computed final correlation scores of product pairs including the first product, the final correlation scores computed by combining correlation scores for two or more behavior indicator types; and transmitting the determined product recommendation.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system, in an accordance with a described implementation;

FIG. 2 is a block diagram of an analytics service transmitting product recommendations to a content source for delivery to a client device, in an accordance with a described implementation;

FIG. 3 is an illustration of a webpage displaying product recommendations, in an accordance with a described implementation;

FIG. 4A is a flow diagram of a process for computing correlation scores for a product pair using contextual user behavior indicators, in an accordance with a described implementation;

FIG. 4B is a block diagram of a system configured to compute correlation scores for a product pair using contextual user behavior indicators, in an accordance with a described implementation;

FIG. 5 is an illustration of computation of a correlation score for two products based on contextual user behavior indicators, in an accordance with a described implementation; and

FIG. 6 is a flow diagram of a process for determining product recommendation using correlation scores computed using contextual user behavior indicators.

Like reference numbers and designations in the various drawings indicate like elements.

### DETAILED DESCRIPTION

According to some aspects of the present disclosure, an analytics service generating product recommendations using contextual user behavior indicators is provided. The analytics service may determine product correlations for substitutes and product correlations for bundles. As used herein, a substitute refers to a pair of products that can be considered alternatives. For example, diapers produced by two different companies may be considered substitutes. Furthermore, as used herein, a bundle refers to a pair of products commonly co-purchased together. For example, a particular camera and a camera bag may be bundles as a customer may purchase them together.

The analytics service may calculate correlation scores for product pairs based on various contextual user behavior indicators. Any combination of the various contextual user behavior indicators may be utilized to correlate products pairs. The contextual user behavior indicators include, but are not limited to, user identification indicator, a search or a campaign keyword indicator, an on-site search keyword indicator, an on-site click URL indicator, and a referral source indicator.

The user identification (referred herein as “user ID”) indicator refers to identification information associated with a user or visitor to a website. For example, the user ID may be a number generated by the analytics service.

The search keyword indicator refers to a keyword that a user enters when searching using an online search engine. The search keyword is treated as an indication of the user's shopping intent. For example, if multiple users searched for a particular keyword, and then ended up on a merchant's website, and purchased a product A or a product B, or both products A and B, then the analytics service may correlate the products A and B. In this example, the products A and B can be considered either bundles or substitutes.

The on-site search keyword indicator identifies users' shopping intent more specifically. Once on a merchant's website, the user may narrow down a list of products that they are looking for using merchant's search engine before the product is found and eventually purchased. For example, the user may search for a product A on the merchant's website, and then buy products A and B. The product B may be an accessory for the product A, and the two products may be determined correlated by the analytics service.

The on-site click URLs indicator refers to situations in which multiple users land on the same product page, and then some users purchase a product A, while other users may visit other webpages on the same or different website, and eventually purchase a product B. In this case, products A and B may be correlated by the same product page P. For example, the product A and product B may be the same product in two different colors.

The referral source indicator refers to users visiting a particular webpage (e.g., a blog), which discusses, mentions, or refers to one or more products. For example, a blog may discuss related products and provide links to merchants' websites associated with these products. As a result of visiting this referral source webpage, the users may click on a merchant's link for the product and eventually buy products. These products (including accessories) may be correlated by the URL of the referral source webpage (e.g., the blog webpage). The purchased products may be the same products in different colors as well as some accessories.

Any combination of these contextual user behavior indicators may be utilized to calculate correlation scores for product pairs. For example, the search keyword indicator and the referral source indicator may be combined to determine a correlation score for product A and product B. In another example, the user ID indicator and the on-site search keyword indicator may be used to determine a product pair correlation score.

Correlation scores may be determined for various combinations of products. In some implementations, correlation scores may be calculated for product pairs. In some embodiments, these product pairs may be identified by selecting related products using product attributes. In other embodiments, correlation scores for all product pairs of products available to the analytics service may be calculated and product pairs with correlation scores that are below a predetermined threshold may be disregarded. The correlation scores may be re-calculated for at least some of the product pairs on an intermittent basis or when sufficient additional data is collected.

To calculate correlation scores for each product pair, the analytics service may first compute correlation scores per product pair, per contextual user behavior indicator. All the computed correlation scores are summed using predetermined weights to get the final correlation score for each product pair. The final correlation scores may be used to infer the most correlated products. For example, these final correlation scores may help determine correlated products per query product.

In some embodiments, a merchant's webpage may request, in real-time or in near real-time, product recommendations for a specific product, and then display the recommended products on the webpage. In particular, the merchant webpage may send a request to the analytics service requesting the product recommendations. The analytics service may in turn determine product recommendations for the particular product based on final correlation scores computed for various product pairs. In some embodiments, product pairs that include the particular product or that are related to the particular product may be selected, and the products in the product pairs that have the highest final correlation scores may be provided as recommendations. In some implementations, an API may be provided for merchants to utilize in their webpages for requesting product recommendations.

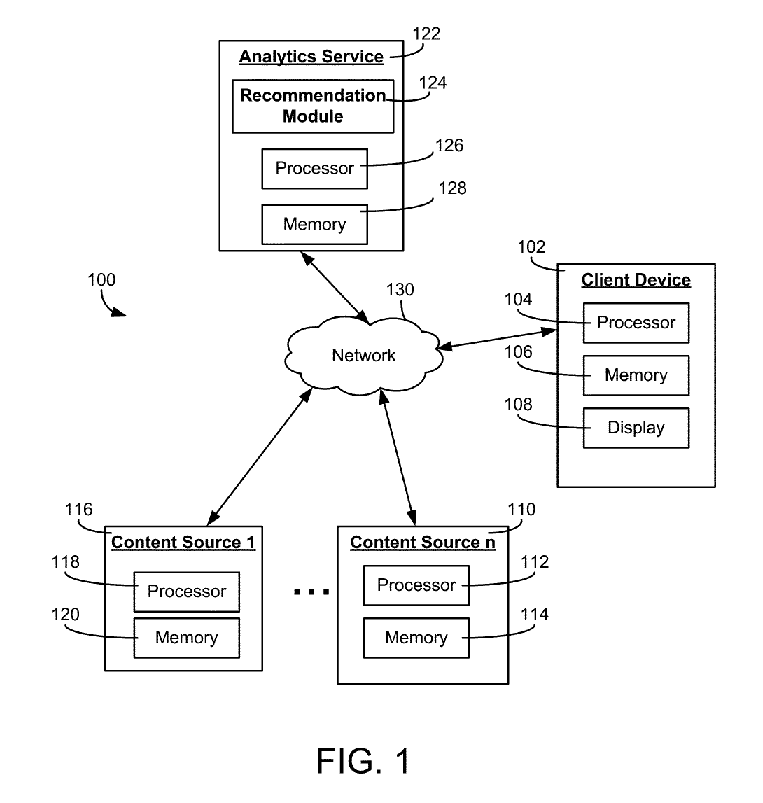

Referring to FIG. 1, a block diagram of a computer system 100 in accordance with a described implementation is shown. The system 100 includes a client device 102, which communicates with other computing devices via a network 130. The client device 102 may execute a web browser or other application (e.g., a video game, a messenger program, a media player, a social networking application, a navigation program, etc.) to retrieve content from other devices over the network 130. For example, the client device 102 may communicate with any number of content sources 116, 110 (e.g., a first content source through nth content source). The content sources 108, 110 may provide webpage data and/or other content, such as images, video, audio, or an application to the client device 102. The content sources may be merchant websites providing product and other information to online users.

The computer system 100 may include an analytics service 122 configured to provide various reports to the administrators of the content sources. In some embodiments, the reports may include information regarding user interaction with the content sources' webpages. For example, a report may be provided including data regarding conversions from users viewing product pages to actual product purchases. At least one report may provide information regarding product recommendations provided by the analytics service 122. For example, the report(s) may display conversion rates on products included in the product recommendations, images, price, number of co-purchasers with the query product, etc.

The analytics service 122 includes a recommendation module 124, which provides product recommendations based on data collected from various websites. When users visit various websites, information regarding their activities on those websites is transmitted to the analytics service 122 for processing. The recommendation module 124 computes correlation scores for product pairs using contextual user behavior indicators and the collected user behavior data.

To protect privacy of participants, data collection may be limited or anonymized in many implementations. In particular, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by third-party content experience selection service or another service. The user may be provided with an option for opting out of collection of any user behavior data.

The network 130 may be any form of computer network that relays information between the client device 102, the content sources 108, 110, and the analytics service 122. For example, the network 130 may include the Internet and/or other types of data networks, such as a local area network (LAN), a wide area network (WAN), a cellular network, satellite network, or other types of data networks. The network 130 may also include any number of computing devices (e.g., computer, servers, routers, network switches, etc.) that are configured to receive and/or transmit data within the network 130. The network 130 may further include any number of hardwired and/or wireless connections. For example, the client device 102 may communicate wirelessly (e.g., via WiFi, cellular, radio, etc.) with a transceiver that is hardwired (e.g., via a fiber optic cable, a CAT5 cable, etc.) to other computing devices in the network 130.

The client device 102 may be any number of different types of user electronic devices configured to communicate via the network 130 (e.g., a laptop computer, a desktop computer, a tablet computer, a smartphone, a digital video recorder, a set-top box for a television, a video game console, combinations thereof, etc.). The client device 102 is shown to include a processor 112 and a memory 114, i.e., a processing circuit. The memory 114 may store machine instructions that, when executed by the processor 112 cause the processor 112 to perform one or more of the operations described herein. The processor 112 may include a microprocessor, ASIC, FPGA, etc., or combinations thereof. The memory 114 may include, but is not limited to, electronic, optical, magnetic, or any other storage or transmission device capable of providing the processor 112 with program instructions. The memory 114 may include a floppy disk, CD-ROM, DVD, magnetic disk, memory chip, ROM, RAM, EEPROM, EPROM, flash memory, optical media, or any other suitable memory from which the processor 112 can read instructions. The instructions may include code from any suitable computer programming language such as, but not limited to, C, C++, C#, Java, JavaScript, Perl, HTML, XML, Python and Visual Basic.

The client device 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of the client device 102 (e.g., a monitor connected to client device 102, a speaker connected to client device 102, etc.), according to various implementations. For example, the client device 102 may include an electronic display 108, which displays webpages and other data received from the content sources 116, 110 and/or the analytics service 122. In various implementations, the display 108 may be located inside or outside of the same housing as that of the processor 104 and/or the memory 106. For example, the display 108 may be an external display, such as a computer monitor, television set, or any other stand-alone form of electronic display. In other examples, the display 108 may be integrated into the housing of a laptop computer, a mobile device, or other form of a computing device having an integrated display.

The content sources 116, 110 may be one or more electronic devices connected to the network 130 that provide content to devices connected to the network 130. For example, the content sources 116, 110 may be computer servers (e.g., FTP servers, file sharing servers, web servers, etc.) or combinations of servers (e.g., data centers, cloud computing platforms, etc.). The content may include, but is not limited to, webpage data, a text file, a spreadsheet, images, search results, and other forms of electronic documents. Similar to the client device 102, the content sources 116, 110 may include processing circuits comprising processors 118, 122 and memories 120, 114, respectively that store program instructions executable by the processors 118, 112. For example, the processing circuit of the content source 116 may include instructions such as web server software, FTP serving software, and other types of software that cause the content source 116 to provide content via the network 130.

Similar to the content sources 116, 110, the analytics service 122 may be one or more electronic devices connected to the network 130. The analytics service 122 may be a computer server (e.g., FTP servers, file sharing servers, web servers, etc.) or a combination of servers (e.g., a data center, a cloud computing platform, etc.). The analytics service 122 may have a processing circuit including a processor 126 and a memory 128 that stores program instructions executable by the processor 126. In cases in which the analytics service 122 is a combination of computing devices, the processor 126 may represent the collective processors of the devices, and the memory 128 may represent the collective memories of the devices.

The client device 102 may identify itself to the analytics service 122 through the use of one or more device identifiers. Device identifiers may include, but are not limited to, cookies, UDIDs, device serial numbers, telephone numbers, or network addresses.

The content sources 116, 110 may provide webpage data to the client device 102. The webpage data may include product information. For example, a website provided by the content source 116 may be a blog. In this example, the website may include links to merchant's products, and upon clicking on one of those links, the user may be redirected to a merchant's website (e.g., provided by the content source 110). Various products may be displayed to the user on a single webpage. In another example, the user may be searching for products or other information on an Internet search engine. The user may then click on one of the links displayed in the search results, which may in turn redirect the user to a merchant's website. In another example, the user may directly type in a merchant's website into the browser on their client device 102, which will cause displaying of merchant's website's webpage.

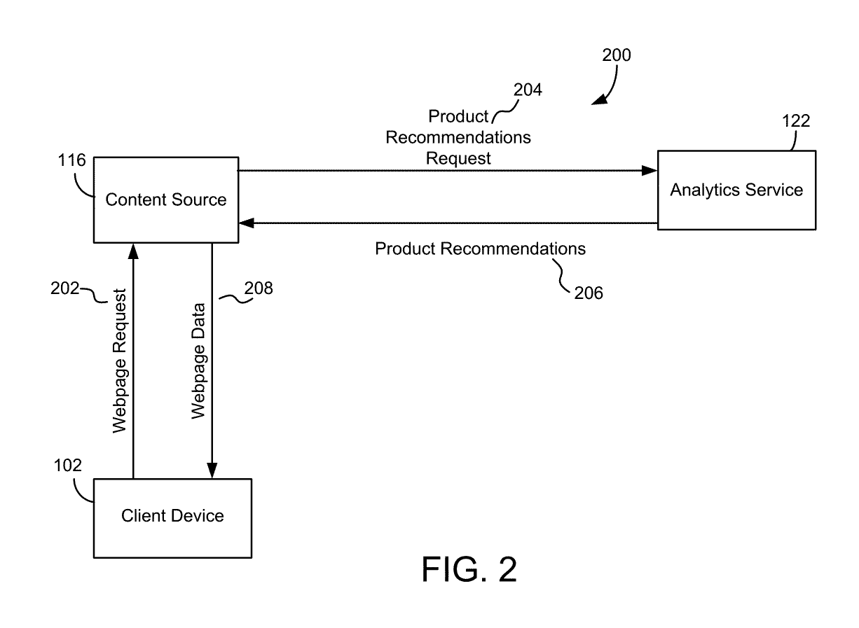

FIG. 2 is a block diagram of the client device 102 receiving products recommendations from the analytics service 122. The client device 102 first sends a webpage request 202 to the content source 116 via the network 130. For example, the webpage request 202 may be a request that conforms to the hypertext transfer protocol (HTTP). The webpage request 202 may include the name of the file to be retrieved. A device identifier, such as a cookie associated with the content source 116, may be included with the webpage request 202 to identify the client device 102 to the content source 116.

The content source 116 receives and processes the webpage request 202. The webpage request may include a request for product recommendations, in which case the content source 116 transmits a request for product recommendations 204 to the analytics service 122. The request for product recommendations 204 may include information regarding one or more products that will be displayed to the user on the client device. The request for product recommendations 204 may include user identification.

In some embodiments, the request for product recommendations 204 may include contextual user behavior information. For example, the contextual user behavior information may include any combination of: information about a website that referred the user to the current website, keyword(s) that the user utilized to search on an online search engine which resulted in the user accessing the current webpage, keyword(s) the user utilized on the current website which resulted in the user getting redirected to the current webpage, etc.

Some user contextual information may be tracked and maintained by the analytics service 122. The analytics service 122 may receive data regarding users' product viewing and purchasing activities on various participating and further process such data. For example, the analytics service 122 may track multiple users landing on the same product page, and some users purchasing the product in one color, while other users went to other pages and purchased the same product in another color. The users can at any time opt out of having their activities tracked. In other embodiments, the analytics service 122 may have access to the contextual user behavior information, which may be tracked/stored/maintained by another system.

Using the contextual user behavior information (e.g., contextual user behavior information included in the webpage request 202 and/or contextual user behavior information that the analytics source may have access to), the analytics service 122 may determine product recommendations, and transmit them back to the content source 116, which in turn transmits them together with other webpage data 208 to the client device 102.

In one example, when a user clicks on a product link on a merchant's website, and the web browser is redirected to the webpage corresponding to the product link, the client device may generate the webpage request 202 to the content source 116, which transmits back the webpage data including product recommendations determined by the analytics service 122.

In another example, the user may make request (e.g., by clicking on a button or another item on the webpage indicating that the user wishes to view product recommendations) for product recommendations, in which case the client device may transmit a request for product recommendations to the content source 116, which in turn may transmit a corresponding request to the analytics service 122.

In some embodiments, the client device 102 may transmit a request for product recommendations directly to the analytics service 122. In these embodiments, an API may be provided to the client device 102 enabling the client device 102 to make the request for product recommendations. Upon receiving the request for product recommendations from the client device 102, the analytics service 122 may determine product recommendations and transmit them back to the client device.

The product recommendations 206 may include various data regarding the recommended products determined by the analytics service 122 including, images, descriptions, videos, animation, etc. The number of product included in the product recommendations 206 may capped to a predetermined maximum number of product recommendations. In another embodiment, the product recommendations request may include the number of product recommendations needed from the analytics service 122.

The product recommendations 206 may be related to recommendations of any type of items including, but not limited to, songs, videos, books, retail merchandise, electronics products, etc. When a user of the client device 102 opens a webpage displaying content regarding a particular product, the analytics service 122 may generate product recommendations 206 for that user and particular product using contextual user behavior indicators. These generated product recommendations 206 may be transmitted back to the client device 102 for display on the webpage.

In some embodiments, not all webpage requests involve the content source 116 requesting product recommendations from the analytics service 122. The webpage request may include a request for product recommendations. In other embodiments, a separate request for product recommendations may be generated by the client device 102 and/or the content source 116 and transmitted to the analytics service 122.

The webpage data 208 is transmitted back to the client device 102 and shown to the user on the display 108. The webpage data 206 may be configured to cause the client device 102 to display a webpage on the display 108 when opened by a web browser application. As a result, the user may be provided with webpage that may include product recommendations for the user. The webpage may be associated with a particular product.

In some embodiments, the webpage data 208 may include code that may cause the client device 102 to directly request product recommendations from the analytics service. In these embodiments, upon receiving the webpage data, the client device 102 may request product recommendations (not shown in FIG. 2) directly from the analytics service 122.

The analytics service 122 may determine product recommendations for a non-browser application on the client device 102 in a similar manner as when product recommendations are provided in conjunction with a webpage. In these implementations, a non-browser application on the client device 102 may send product recommendations request to the analytics service 122 periodically or in response to a certain event occurring in the application.

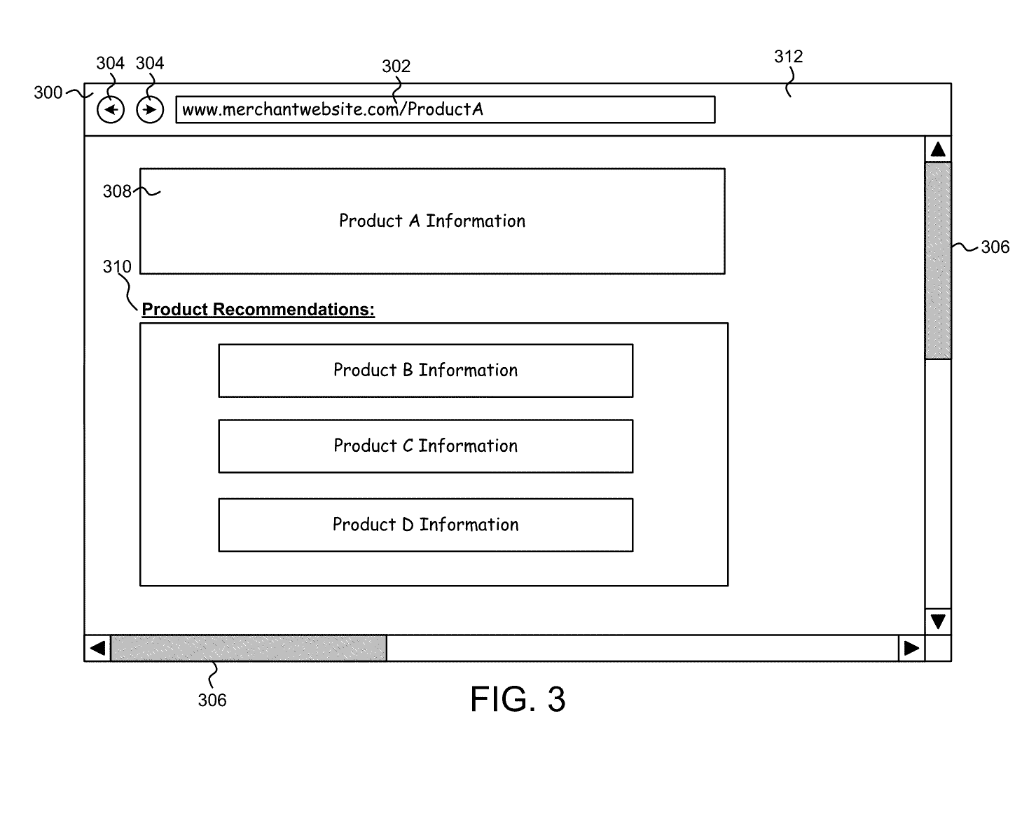

Referring now to FIG. 3, an illustration is shown of the client device display 108 showing a webpage 312 to the user. In one embodiment, the user may directly type the webpage URL 302 into the browser, and access the webpage 312. In another embodiment, the user searched for information related to the webpage using an Internet search engine, and clicked on the webpage URL 302 provided in the search results. In another embodiment, the user clicked on a link associated with the webpage 312 on another website, and was then redirected to the webpage 312.

The webpage 312 displays product A information 308. The product A information 308 may include one or more images of the product A, description, and any other information associated with the product A. The webpage 312 may be dedicated to the product A and its related information.

The webpage 312 further displays product recommendations 310. The product recommendations 310 include information for three products B, C, and D. Although only three product recommendations are shown, any other number of product recommendations (e.g., 5, 10, etc.) may be displayed to the user. The product recommendations 310 are shown vertically with product C shown between products B and D. The product recommendations 310 can be shown in any other visual configuration. For example, the product recommendations 310 can be shown in a sliding bar. In another example, the product recommendations 310 can be shown in a single horizontal line. In some implementations, the product recommendations may be shown in one area of the webpage 312. For example, as shown in FIG. 3, the product recommendations 310 are shown together directly under the product A information 308.

The product recommendations 310 may include images of the recommended products and/or information related to those products. For example, each product recommendation may include an image of the corresponding product. The user may click on an image shown in one of the product recommendations, which would in turn redirect the web browser to a webpage associated with the recommended product.

The client device 102 may request the product recommendations from the content source 116 or directly from the analytics service 122. In some embodiments, the client device 102 transmits a request for product recommendations to the analytics service 122 including information regarding one or more products shown on the webpage 312. The request may further include information regarding the user including, but not limited to, user identification information, contextual user behavior information, and/or other information.

The display 108 is in electronic communication with the processor 104, which in turn causes visual indicia to be displayed on the display 108. As shown, the processor 104 may execute a web browser 300 stored in the memory 106 of the client device 102, to display indicia of the content received by the client device 102 via the network 130. In other implementations, another application executed by the client device 102 may incorporate some or all of the functionality described with regard to the web browser 300.

The web browser 300 may operate by receiving input of a uniform resource locator (URL) via a field 302 from an input device (e.g., a pointing device, a keyboard, a touch screen, etc.). For example, the URL, http://www.merchantwebsite.com/ProductA, may be entered into the field 302. Processor 104 may use the inputted URL to request data from a content source having a network address that corresponds to the entered URL. In other words, the client device 102 may request content accessible at the inputted URL. In response to the request, the content source may return webpage data and/or other data to the client device 102. The web browser 300 may analyze the returned data and cause visual indicia to be displayed by the display 108 based on the data.

In general, the webpage data may include text, hyperlinks, layout information, and other data that may be used to provide the framework for the visual layout of the webpage 306. In some implementations, the webpage data may be one or more files of webpage code written in a markup language, such as the hypertext markup language (HTML), extensible HTML (XHTML), extensible markup language (XML), or any other markup language. In some implementations, the webpage data may also include additional URL information used by web browser 300 to retrieve additional indicia displayed on webpage 312.

The web browser 300 may include a number of navigational controls associated with the webpage 312. For example, the web browser 300 may be configured to navigate forward and backwards between webpages in response to receiving commands via inputs 304 (e.g., a back button, a forward button, etc.). The web browser 300 may also include one or more scroll bars 306, which can be used to display parts of webpage 312 that are currently off-screen. For example, the webpage 312 may be formatted to be larger than the screen of the client device 102. In such a case, the one or more scroll bars 304 may be used to change the vertical and/or horizontal position of webpage 312 on the display 108.

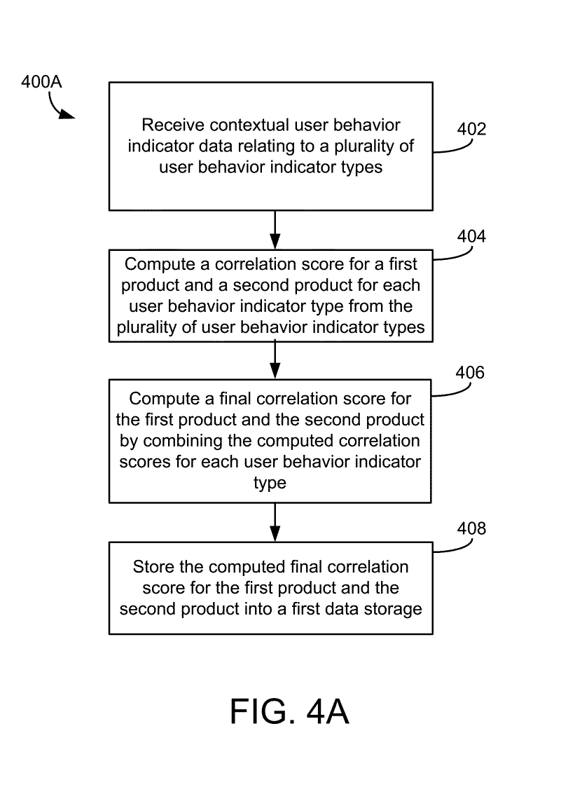

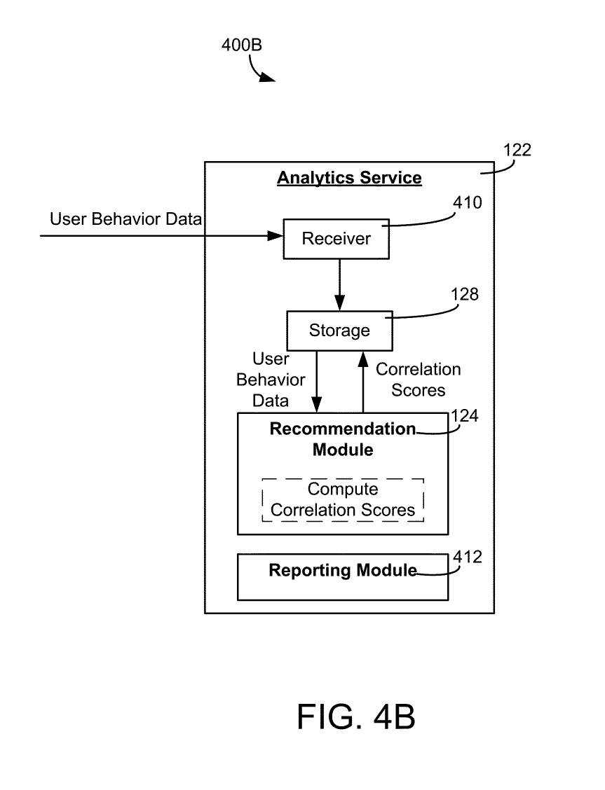

FIG. 4A is a flow diagram of a process 400 for computing correlation scores for a product pair using contextual user behavior indicators. The process 400A can be implemented on a computing device (e.g., the analytics service 122). In one embodiment, the process 400A is encoded on a computer-readable medium that contains instructions that, when executed by the computing device, cause the computing device to perform operations of the process 400A.

At block 402, contextual user behavior indicator data is received. The contextual user behavior indicator data is related to a plurality of user behavior indicator types. In some embodiments, the plurality of user behavior indicator types, may include any combinations of, but are not limited to, user identification, search keyword, on-site search keyword, on-site click URL, and referral source. The data may be retrieved from local storage or another accessible storage. In another embodiment, the data is received from another system or storage upon transmitting a request for this data.

A correlation score is computed (block 404) for a first product and a second product for each user behavior indicator type from the plurality of user behavior indicator types. When no data is available for a user behavior indicator type, then the correlation score may be assigned zero for that user behavior indicator type. In some implementations, a correlation score is computed for a first product and a second product for at least one or more of the user behavior indicator types from the plurality of user behavior indicator types.

In some embodiments, the first product and the second product may be selected randomly from a set of available products. In other embodiments, the first and the second products may be selected using some product attributes (e.g., price, color).

To compute the user identification indicator correlation score, the following formula may be utilized: score of pair <A,B> with visitor id c=S(A,B,c)=(visit_ids(A,c)∩ visit_ids(B,c))/(visit_ids(A,c)∪ visit_ids(B,c)). The visit_ids(A,c) is the set of visit ids of purchases of item A under the specific visitor id c, while the visit_ids(B,c) is the set of visit ids of purchases of item B under the specific visitor id c. In some embodiments, the user identification indicator correlation score may be a result of the total number of visit ids, which may be calculated by determining the total number of visit_ids in the intersection of a set of visit_ids of purchases of item A under the specific visitor id c and a set of visit_ids of purchases of item B under the specific visitor id c, divided by the total number of visit_ids, which may be calculated by determining the total number of visit_ids in the union of a set of visit_ids of purchases of item A under the specific visitor id c and a set of visit_ids of purchases of item B under the specific visitor id c. Visit_ids may be identifiers that are assigned to the actual purchases of an item by a particular visitor having visitor id c.

To compute the search keyword indicator correlation score, the following formula may be used: score of pair <A,B>with keyword c=S(A,B,c)=min(count(A,c), count(B,c))̂2/(max(count(A,c), count(B,c)). The count(A,c) is the number of purchases of item A under the specific keyword c. The count(B,c) is the number of purchases of item B under the specific keyword c. This same formula may utilized for each of the remaining user behavior indicators including, but not limited to, the internal search keyword indicator, the request URL indicator, and the referral source indicator.

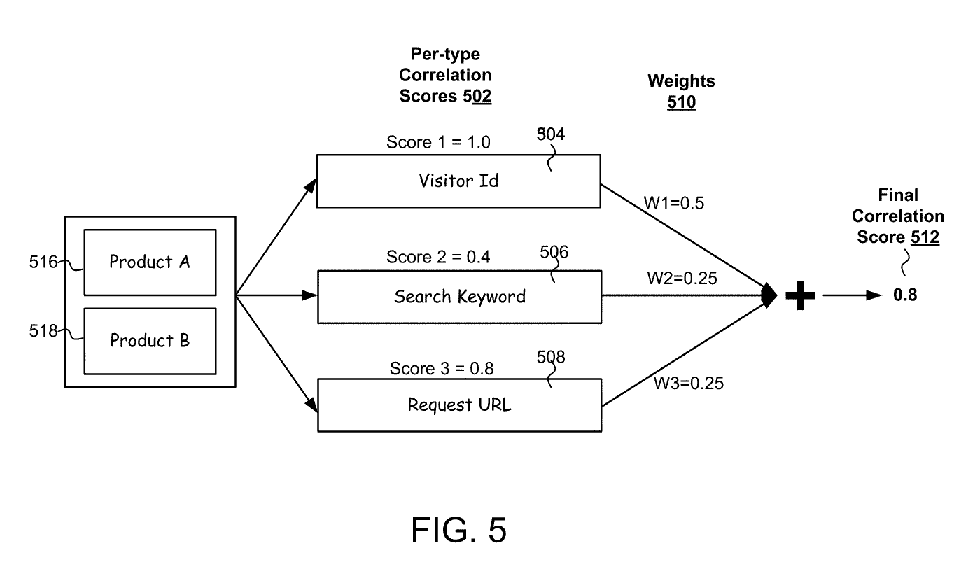

If multiple search keyword indicator correlation scores are calculated for the same product pair, a composite search keyword indicator correlation score may be calculated. For example, if a separate correlation score for product pair A,B is calculated for each of the keywords a, b, and c, a composite search keyword correlation score may be calculated based on these three scores (e.g., by averaging the three scores, by adding the three scores, etc.). This composite search keyword indicator correlation score may be used as the score 506 as shown in FIG. 5 to determine the final correlation score for a pair of products. If multiple internal search keyword indicator correlation scores are calculated for the same product pair, a composite internal search keyword indicator correlation score may calculated (e.g., by averaging the internal search keyword indicator correlation scores, by adding the internal search keyword indicator correlation scores, etc.). In this manner, a composite correlation score may be calculated for each user behavior indicator.

A final correlation score is computed (block 406) for the first product and the second product by combining the computed composite correlation scores calculated for each user behavior indicator type. In some embodiments, the correlation scores computed in block 404 may be summed with weights. A weight may be predetermined or pre-assigned to each user behavior indicator type. For example, a weight having value 0.25 may be assigned to the keyword search indicator. Any weight values may be utilized.

The computed final correlation score is stored (block 408) into a first data storage. The first data storage may be associated with or be accessible to the system performing the steps of the process 400A (e.g., the analytics service 122). As new user behavior data is received, the final correlation score for the first product and the second product may be re-calculated. For example, the final correlation score may be recalculated on an intermittent basis.

The steps 404-408 may be repeated for each product pair from a plurality of additional product pairs. The computed final correlation scores for various product pairs may be utilized to make product recommendations. The products that have high correlation scores may be recommended as product recommendations.

FIG. 4B is a block diagram of the analytics service 122. The analytics service 122 may provide websites' administrators with various reports regarding user behavior on merchant's websites. A report module 412 may generate these various reports using user behavior data collected and stored in the storage 128 or another data storage. In some embodiments, at least one report may provide information regarding user interactions with product recommendations that were generated by the recommendation module 124. For example, the report may include information regarding number of purchases of products that were recommended by the analytics service 122.

A receiver 410 receives user behavior data from client devices, content sources, or other computing devices. User behavior data may be collected and transmitted to the analytics service 122 for processing and storage in the storage 128 or another storage accessible to the analytics service 122. The user is allowed to opt-out out of this data collection.

The processed and stored user behavior data may be then utilized by the recommendation module 124, the report module 412, or any other module or component of the analytics service. As shown, the recommendation module 124 retrieves user behavior data from the storage 128, and computes correlation scores for products pairs using a process illustrated in FIGS. 4A and 5. The computed correlation stores are then stored in the storage 128.

FIG. 5 provides an example of calculation of the final correlation score. As shown, a final correlation score 512 is computed for products 516 and 518. In particular, correlation scores 502 are calculated per user behavior indicator type. Specifically, score of 1.0 is determined for the visitor id indicator 504 (referred to as the user id throughout). Furthermore, a score of 0.4 is determined for the search keyword indicator 506, and a score of 0.8 is calculated for the request URL indicator 508. As shown, only three contextual user behavior indicators received a score. The other user behavior indicators may not have had sufficient data to calculate accurate correlation scores, in which case the correlation score for those user behavior indicators may be zero.

Weights 520 are shown corresponding to each user behavior indicator. As illustrated, a weight having value 0.5 corresponds to the user identification indicator, a weight having value 0.25 corresponds to the search keyword indicator, while a weight having value 0.25 corresponds to the request URL indicator. Using the correlation scores 502 and weights 510, the final correlation score 512 is computed. The final correlation score is computed by 1*0.5+0.4*0.25+0.8*0.25, which equals 0.8. Thus, the final correlation score equals 0.8. Other products pairs may have higher/lower final correlation scores.

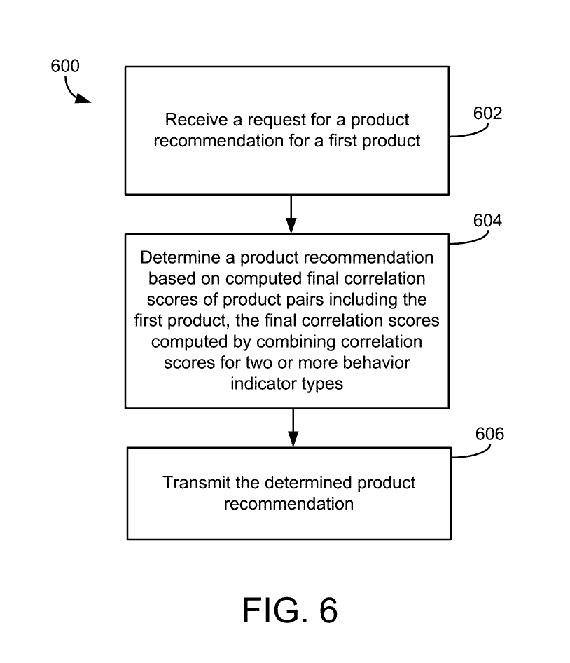

FIG. 6 is a flow diagram of a process 600 for determining product recommendations. The process 600 can be implemented on a computing device (e.g., the analytics service 122). In one embodiment, the process 600 is encoded on a computer-readable medium that contains instructions that, when executed by the computing device, cause the computing device to perform operations of the process 600.

The process 600 includes receiving (602), over a network, a request for a product recommendation for a first product. The request may be received directly from a client device (e.g., the client device 102). In other embodiments, the request for product recommendations may be received from a content source (e.g., the content source 116) or another source.

A product recommendation based on computed final correlation scores of product pairs is determined (block 604). The product pairs may be selected to include products that are similar to the first product (e.g., products that share certain characteristics with the first product) and/or that include the first product. The final correlation scores may be pre-computed by combining correlation scores for two or more behavior indicator types. The final correlation scores may be computed using the process 400. In some embodiments, one or more product pairs with highest final correlation scores may be selected and product(s) in those product pairs may be included in the determined product recommendation(s).

The determined product recommendation is transmitted (606) back to the requestor (e.g., to the client device/the content source). The product determination may include information regarding the recommended product including, but not limited to, images, description, animation, videos, etc. Multiple product may be determined as recommendations and transmitted back to the requestor.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method for inferring product correlations, the method comprising:
receiving contextual user behavior indicator data relating to a plurality of user behavior indicator types;
computing a correlation score for a first product and a second product for each user behavior indicator type from the plurality of user behavior indicator types;
computing a final correlation score for the first product and the second product by combining the computed correlation scores for each user behavior indicator type; and
storing the computed final correlation score for the first product and the second product into a first data storage.

2. The method of claim 1, further comprising:
computing a correlation score for additional products for each behavior indicator from the plurality of behavior indicators; and
computing a final correlation score for each product pair in the plurality of additional product products by combining the computed correlation scores for each behavior indicator type.

3. The method of claim 2, further comprising:
receiving a user query; and
determining one or more correlated products based on the user query and the computed final correlation scores.

4. The method of claim 1, wherein combining the computed correlation scores includes summing the computed correlation scores using one or more weights, with each behavior indicator having an assigned weight.

5. The method of claim 1, wherein the plurality of behavior indicators include a search keyword behavior indicator.

6. The method of claim 1, wherein the plurality of behavior indicators include an merchant website search keyword behavior indicator.

7. The method of claim 1, wherein the plurality of behavior indicators include an website click URL behavior indicator.

8. The method of claim 1, wherein the plurality of behavior indicators include a referral source behavior indicator.

9. A system for inferring product correlations, the system comprising:
a receiver configured to receive contextual user behavior indicator data relating to a plurality of user behavior indicator types;
a recommender module configured to compute a correlation score for a first product and a second product for each user behavior indicator type from the plurality of user behavior indicator types, and compute a final correlation score for the first product and the second product by combining the computed correlation scores for each user behavior indicator type; and
a data storage configured to store the computed final correlation score for the first product and the second product into a first data storage.

10. The system of claim 9, wherein the recommender module further configured to:
compute a correlation score for additional products for each behavior indicator from the plurality of behavior indicators; and
compute a final correlation score for each product pair in the plurality of additional product products by combining the computed correlation scores for each behavior indicator type.

11. The system of claim 10, wherein the receiver further configured to receive a user query; and the recommender module further configured to determine one or more correlated products based on the user query and the computed final correlation scores.

12. The system of claim 9, wherein combining the computed correlation scores includes summing the computed correlation scores using one or more weights, with each behavior indicator having an assigned weight.

13. The system of claim 9, wherein the plurality of behavior indicators include a search keyword behavior indicator.

14. The system of claim 9, wherein the plurality of behavior indicators include an merchant website search keyword behavior indicator.

15. The system of claim 9, wherein the plurality of behavior indicators include an website click URL behavior indicator.

16. The system of claim 9, wherein the plurality of behavior indicators include a referral source behavior indicator.

17. A computer-readable storage medium having machine instructions stored therein, the instructions being executable by a processor to cause the processor to perform operations comprising:
receiving a request for a product recommendation for a first product;
determining a product recommendation based on computed final correlation scores of product pairs including the first product, the final correlation scores computed by combining correlation scores for two or more behavior indicator types; and
transmitting the determined product recommendation.

18. The computer-readable storage medium of claim 17, the correlation scores are computed for each product pair and at least some behavior indicator types from a plurality of user behavior indicator types.

19. The computer-readable storage medium of claim 18, wherein the plurality of behavior indicators include a search keyword behavior indicator.

20. The computer-readable storage medium of claim 18, wherein the plurality of behavior indicators include an merchant website search keyword behavior indicator.

21. The computer-readable storage medium of claim 18, wherein the plurality of behavior indicators include an website click URL behavior indicator.

22. The computer-readable storage medium of claim 18, wherein the plurality of behavior indicators include a referral source behavior indicator.
